(19) United States
(12) Patent Application Publication
(10) Pub. No.: US 2011/0266832 A1
(43) Pub. Date: Nov. 3, 2011

(54) PARKED VEHICLE DOOR GUARD

(76) Inventor: Gary B. Spiegel, Kingston, NY (US)

(21) Appl. No.: 12/772,182

(22) Filed: May 1, 2010

(51) Int. Cl. B60R 19/00

(52) U.S. Cl. 296/187.03

(57) ABSTRACT

A free-standing door guard is disclosed, which enables vehicle owners to protect their vehicles from damage caused by inadvertently opening a vehicle door into another adjacently parked vehicle, garage wall, other hard surface or object or damage caused by an object falling against a vehicle by facilitating easy deployment of the door guard along side a vehicle, independent of any physical structure such as an overhead garage door rail, ceiling, or the like. The vehicle door guard apparatus employs a resilient, impacting absorbing panel to cushion the opening vehicle door and is available in a foldable version to reduce overall carrying length. Integrated expandable floor supports may also be configured with a roll stop feature. The door guard assembly may include a height adjustment capability that allows a user to place the resilient impact absorbing panel at a height that maximizes protection of adjacently parked vehicles.

### BACKGROUND

1. Field of the Invention

The invention relates generally to vehicle equipment, and more particularly to vehicle protection equipment.

2. Description of the Related Art

Automobiles are retaining value longer through the use of higher quality materials and easier and less frequent preventive maintenance. One aspect that contributes to the determination of a retained value of a vehicle is the external appearance. Consequently, products that enhance and extend the life of the high quality appearance of automobiles are readily available to consumers. In addition, consumer products that allow for correction of minor dents, surface scratches, and the like have provided some benefit to vehicle owners in this regard. However, a most challenging and prevalent problem related to vehicle exterior quality is deep damage to paint and/or door surfaces resulting from impacts of opening doors of adjacently parked vehicles in a garage, parking lot, or other similar zone. Damage related to vehicle door opening is known to occur on the broad side door panels when a vehicle door is opened against such door panel. However, damage can also occur to an edge of a vehicle door when it is opened against a rigid surface, such as another vehicle, a wall, or the like.

Because damage caused to vehicle doors during access to a parked vehicle can often result in damage that cannot be readily remedied by consumers, repairs to remedy such damage is often expensive and time consuming. Consequently a variety of devices have been invented to help vehicle owners avoid such damage. These devices can be generally categorized into three broad groups: vehicle attached devices, suspended devices, and parking zone affixed devices. Each of these groups attempts to limit damage to car doors in very different ways.

Vehicle attached devices have the benefits of being available for deployment when a vehicle so adapted is parked. Consequently, deployment is required when a vehicle is parked to gain the benefit of the device. In addition, such a device must be attached to the vehicle which by itself may raise issues with respect to vehicle external appearance. Tradeoffs of appearance, weight, exposure to elements during vehicle operation, manual versus automatic deployment, and the like also characterize these devices.

Suspended devices can generally be deployed in a substantially enclosed parking structure, such as a garage, that includes a means for holding such a suspended device (e.g. a ceiling). A suspended device generally includes a tarp or other padded flexible sheet disposed at vehicle door height so that a vehicle door will strike the sheet when it is opened. Such a device, once installed in a parking garage is generally easy to use for the purpose of mitigating damage to a vehicle door that is parked in the garage at least because it generally does not require redeployment each time a vehicle is parked. Suspended devices require nearly permanent, specialized installation to a garage roof or overhead garage door rail system and are generally not usable in outdoor parking zones, such as a driveway or open-air parking lot.

Parking zone affixed devices installed in a parking zone are also known in the art. Special tools are needed to install such devices in an environment with a typical vehicle parking floor surface such as concrete or asphalt. Furthermore, the fixed position and dimensions of such devices restrict them to one parking space, and generally to one size type of vehicle. Such devices also are continuously exposed to the elements, which can cause accelerated wear to the device, as well as present challenges in winter climates that require snow removal, such as plowing, for example. Such devices also confer no benefit to a vehicle owner when their vehicle is parked in a spot other than the spot adjacent to the device.

### SUMMARY

Vehicle owners may protect their vehicles from dings, scrapes, dents and related damage caused by inadvertently opening a vehicle door into another adjacently parked vehicle, garage wall, or other hard surface or object by employing a free-standing vehicle door guard apparatus as described herein. Likewise, the door guard apparatus can protect a door panel or side panel of vehicle from being damaged by an adjacently parked vehicle door being opened against the door or side panel by occupying the space between vehicles parked in adjacent parking spaces, such as side by side in a garage, driveway, or the like. Similarly, the door guard apparatus can protect a side of a car from an object falling against it. Deployment in a garage is one envisioned use of the door guard apparatus and garages can include other objects such as bicycles left leaning against a wall, pole, barrel, and the like but in proximity to the vehicle. Also, the door guard apparatus can protect a vehicle from damage caused by moving an object, such as a garbage barrel past the vehicle. The free-standing vehicle guard door apparatus can be conveniently positioned to protect parked vehicle doors independent of any physical structure such as an overhead garage door rail, ceiling, or the like. Because the apparatus is free-standing, it can be repositioned as needed to allow access to the parked vehicles through the protected doors.

The door guard apparatus can also function as a safety shield for an occupant exiting or entering a vehicle. By establishing a barrier between the vehicle door and other objects or vehicles in the vicinity of the vehicle door, an occupant exiting or entering a vehicle may be shielded from an object such as a falling bicycle, a door of an adjacent car being opened, and the like. This may be particularly beneficial for children entering or exiting a vehicle.

The vehicle door guard apparatus safely restricts the opening of an adjacently parked vehicle door by employing a resilient, impacting absorbing panel to cushion the opening vehicle door. The apparatus is made with resilient material so that repeated impacts by vehicle doors may not substantially reduce its protective properties. By absorbing the impact of the vehicle door, the apparatus is designed to minimally affect the door or the door hinge operation. To further improve the impact absorbing capabilities of the door guard apparatus, the posts supporting the resilient impacting absorbing panel may be fixed to a base with springs that allow the panel to tilt slightly when impacted.

Designed for easy transportation and setup, the door guard apparatus is available in a foldable version that allows the user to fold the apparatus lengthwise to approximately one-third its extended length. Setup is further simplified by floor supports that can be folded against the apparatus and deployed for convenient positioning in a garage, parking lot, driveway, or other vehicle parking area. The floor supports may also provide stability to the door guard. In addition to providing stability, a portion of the floor supports may be configured with a roll stop feature that informs a vehicle operator when the vehicle has pulled into a parking space protected by the door guard.

The door guard apparatus can be used for a wide range of vehicles because it can be flexibly configured for low sports cars as well as high vehicles such as SUVs or trucks through a novel height adjustment capability that allows a user to place the resilient impact absorbing panel at a height that maximizes protection of adjacently parked vehicles. Generally, the door guard can be adjusted through a range of heights from approximately twenty-seven inches to approximately thirty-six inches.

In an aspect of the invention, methods and systems for vehicle door protection may include an apparatus for preventing damage to facing sides of two vehicles parked in adjacent parking spaces, the damage resulting from opening a door of one of the vehicles toward the other vehicle, including a resilient door guard having left and right impact absorbing surfaces and a top surface; a horizontally elongated base; a plurality of posts attached to the base and extending upward from the base, wherein the plurality of posts is disposed between the left and right impact absorbing surfaces of the door guard thereby holding the door guard upright; and a plurality of adjustable floor supports resting on at least one of the parking spaces and moveably attached to the base for stably maintaining the door guard between the two vehicles. In the aspect, the base may include three segments attached by hinges therebetween and the door guard may include three sections flexibly attached therebetween above the hinges for folding the apparatus horizontally. Further in the aspect, the plurality of posts each may include two sections that are slidably attached; a first section holding the door guard and being vertically slidable relative to a second section attached to the base. The door guard can be vertically positioned so that door guard top surface can be positioned in the range of 27″ to 36″ above the parking space by sliding the first post section upward relative to the second post section.

In the aspect, the posts are mounted to the base by a spring for allowing the door guard to tilt relative to the base in response to the vehicle door impacting the door guard. In addition, a plurality of flags may be included for disposing at various horizontal positions along a top of the door guard including pushing a portion of the flag into the door guard through the door guard top surface.

In the aspect, at least one of the adjustable floor supports includes a proximal end for attaching to the base and a distal end that comprises a roll stop to facilitate positioning a vehicle relative to the apparatus and the door guard remaining upright in response to an impact from an opening car door.

In another aspect of the invention, methods and systems of vehicle door and side panel protection may include an apparatus to facilitate preventing damage to horizontal surfaces of a vehicle parked in a parking space that may include a plurality of vertically elongated posts, each having a bottom end and a top end; a first resilient, impact-absorbing panel overlaying a portion of at least one vertical face of the plurality of posts, the panel attached to the posts; a base attached below the bottom end of the plurality of posts, thereby holding the posts and panel upright; and a plurality of adjustable floor supports moveably attached to the base for positioning the base aligned with and proximal to the vehicle parking space with the impact absorbing panel being disposed between the parking space and the posts, the floor supports resting on the parking space. Further in the aspect, the methods and systems may include a second resilient impact absorbing panel overlaying a vertical face of the plurality of posts opposite the first panel, the second panel attached to the posts, thereby disposing the second panel between the posts and an adjacent parking space. Alternatively, in the aspect, the first resilient, impact absorbing panel overlays a portion of a vertical face of the plurality of posts that is opposite to the vertical face overlaid by the panel, thereby disposing the impact absorbing panel between the posts and an adjacent parking space.

In a variation of the aspect, the base may include three segments attached by hinges therebetween and the panel may include three sections flexibly attached therebetween above the hinges for folding the apparatus horizontally. The aspect of the invention may include height adjustability wherein the plurality of posts each comprises two sections that are slidably attached; a first section holding the panel and being vertically slidable relative to a second section attached to the base. The height adjustable variation of the invention may be vertically positioned so that an upper extent of the panel is positionable in the range 27″ to 36″ above the parking space by sliding the first post section upward relative to the second post section.

In yet another variation of the aspect, at least one of the adjustable floor supports includes a proximal end for attaching to the base and a distal end that comprises a roll stop to facilitate positioning a vehicle relative to the apparatus.

In yet another aspect of the invention, methods and systems for preventing damage to a vehicle side panel or door may include a method of preventing damage to a vehicle door parked on a parking surface that includes disposing a resilient impact absorbing door guard in a vertical orientation over a horizontally elongated base that is positioned aside the vehicle door within the opening radius of the vehicle door; supporting the base with a plurality of floor supports that are moveably attached to the base and that rest on the parking surface; and supporting the impact absorbing door guard with posts that are mounted to the base, wherein the door guard is disposed between the vehicle and the posts. In the aspect the posts are mounted to the base by a spring for allowing the door guard and posts to tilt relative to the base in response to the vehicle door impacting the door guard. Further in the aspect, at least one of the floor supports includes a proximal end for attaching to the base and a distal end that comprises a roll stop to facilitate positioning a vehicle relative to the door guard. In an alternative embodiment, of the aspect, at least one of the posts is vertically elongated to facilitate connection to an overhead garage door rail.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts an end section view of an embodiment of the fully deployed free-standing door guard apparatus;

FIG. 2 depicts an end view of an alternate deployment of the free-standing door guard apparatus;

FIG. 3 depicts an end view of the free-standing door guard apparatus with retracted floor supports;

FIG. 4 depicts a side view of a portion of a foldable embodiment of the door guard apparatus;

FIG. 5 depicts a side view of an embodiment of the door guard apparatus with optional indicator flags;

FIG. 6 depicts a top view of an embodiment of the door guard apparatus;

FIG. 7 depicts an end view of a deployed height adjustable embodiment of the door guard apparatus; and

FIG. 8 depicts various views of a height adjustment mechanism of the embodiment of FIG. 7.

FIG. 9 depicts an exploded view of a modular embodiment of a portion of the door guard apparatus invention.

### DETAILED DESCRIPTION

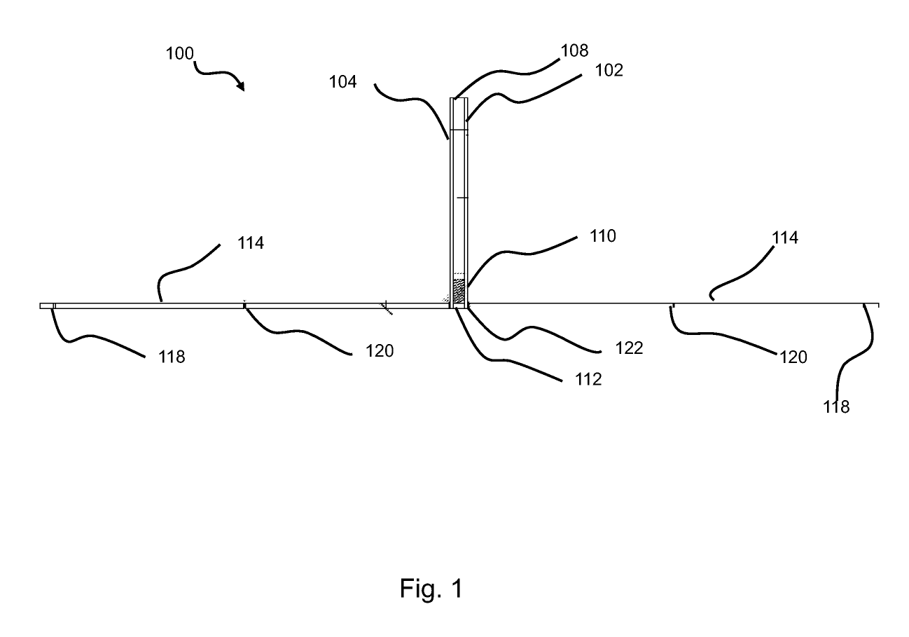

Referring to FIG. 1, an end section view of an embodiment of a fully deployed free-standing door guard 100 is shown. The door guard 100 may include a vertical portion, a base, and a horizontal portion joined by the base. The door guard may be positioned near a side of a vehicle by deploying the horizontal portion which may include a set of legs or floor supports. The vertical portion of the free-standing door guard 100 may include a first resilient, impact-absorbing panel 102 and optionally a second resilient, impact-absorbing panel 104 that may each be attached on opposite sides of a plurality of posts 108. The vertical portion may be attached to a base 112 by post joints 110. The post joints 110 may be flexible and may each comprise a semi-stiff spring that connects the base 112 to each of the plurality of posts 108 to facilitate positioning the vertical section vertically when the spring is at rest while allows the vertical section to sway relative to the base 112 when a force is applied to either of the first or second resilient impact absorbing panels. Such a force may be the result of opening a door of a vehicle parked along side the free standing door guard 100. Alternatively, the post joints 100 may form rigid connections between the posts 108 and the base 112.

The base 112 may be a horizontally elongated member and in addition to supporting the vertical portion, may be attached to the horizontal portion that may include a plurality of expandable floor supports 114. Sets of the floor supports 114 may be deployable on either side of the vertical portion as shown in FIG. 1. Each floor support of the plurality of floor supports 114 may be attached to the base 112 by a flexible hip joint 122 that may allow the floor support to be repositioned relative to the base 112. In an embodiment, the flexible hip joint 122 may include a hinge that allows the horizontal portion to fold up against the vertical portion. The hip joint 122 may include a locking feature that may facilitate keeping each floor support 114 in a deployed position.

The horizontal portion may include a plurality of expansion joints 120 to facilitate extending the length of the floor supports 114, and at least one anti-slip receptacle 118 for receiving a device that may assist in keeping the floor support 114 in a deployed position. In an embodiment, the anti-slip receptacle 118 may receive a rubberized foot that may make slip-resistant contact with a parking surface on which the apparatus 100 is deployed. In an embodiment, the expansion joints 120 may each include a hinge that allows the floor supports 114 to expand by unfolding at the hinge. In this embodiment, the floor supports 114 may include a plurality of folding sections.

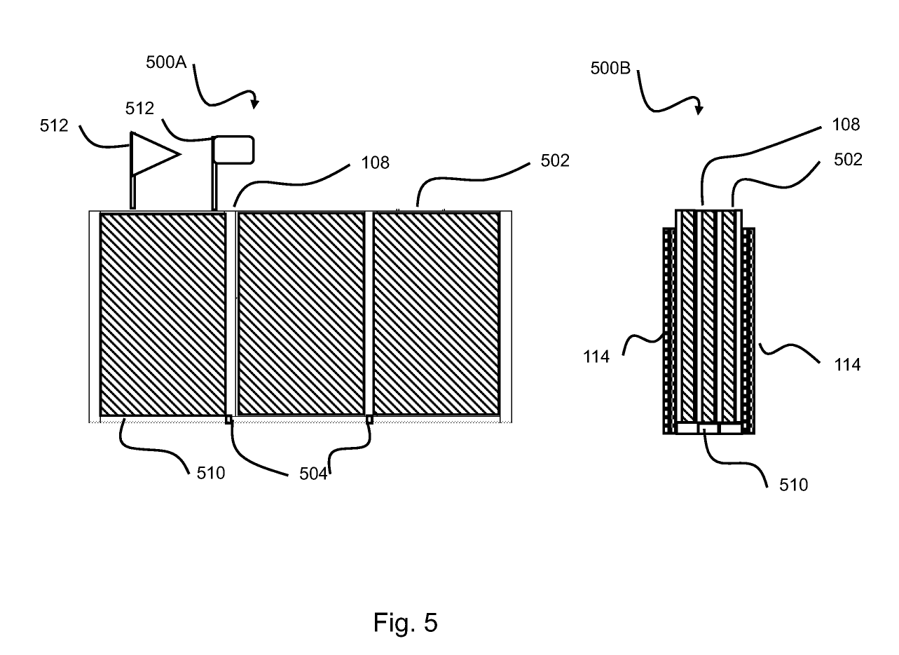

The vertical portion of the free standing door guard apparatus 100 depicted in FIG. 1 may preferably be configured in the general range of twenty-seven to thirty-five inches tall. The vertical portion may also be approximately two and one-half to three and one-half inches in width. The vertical portion and the base may be approximately seventy-two inches long as depicted in FIGS. 4-6 (which are described below). Each fully deployed floor support 114 may extend out from the base approximately seventy inches and may be hinged near the midpoint or approximately at thirty-five inches from the base.

The first and second resilient, impact-absorbing panels 102 and 104 may be constructed of various materials that are suitable for resiliently receiving a sharp impact of an edge of an opening car door while both suddenly stopping the opening motion of the door and protecting the door, door edge, and door hinges from damage due to the sudden stop. An appropriate material may also include features that allow the material to absorb a portion of the impact force by momentarily deforming before substantially recovering its initial shape. One example of such material may include urethane foam, also known as memory foam and variously marketed under names such as TEMPUR-PEDIC. Other types of material include fabric covered batting, gel filled foam, carpet padding, carpet, and the like. In addition, various other foam-like materials, including dense open-cell foam may be suitable for use. Thickness of the panels 102 and 104 may range from approximately one-half inch to approximately three and one half inches.

In addition to being attached to the posts 108, the first and second resilient, impact-absorbing panels 102 and 104 may be co-joined during assembly of the apparatus 100 to form a substantially solid panel that establishes the width of the door guard 100. Alternatively, panels 102 and 104 may be produced as a single panel that provides functionality of the two panels as described herein. In a single panel embodiment, the single panel may be fabricated with vertically oriented apertures for inserting the posts 108. In yet another embodiment, panels 102 and 104 may be joined by a mating sheet (not shown herein) that may provide additional structural support to the panels, such as a semi-flexible plastic sheet. In such co-joined or single construction embodiments, urethane foam and the like may be a preferred material.

Exterior surfaces of the panels 102 and 104 may be decorated with indicia (e.g. brands such as NASCAR, sports team logos, and the like), designs (e.g., street scenes, sunsets, oceans, forests, custom art, vehicles, and the like), horizontal reference marks for aiding a driver in parking a vehicle along side the door guard 100, and the like. The panels may have various shapes including rectangular, oval, vehicle outline, vehicle door outline, and the like.

In a rectangular shaped embodiment, the panels 102 and 104 may be approximately twenty-four to thirty-five inches tall, approximately sixty to seventy-two inches long, and one-half to three inches thick. When combined with other capabilities described herein, such as horizontal fold-ability and/or height adjustability other dimensions of the panels 102 and 104 are possible.

The posts 108 may be fabricated from a variety of materials, but generally may have characteristics such as strength, rigidity, light weight, and the like. Extruded aluminum tubing is one embodiment of the posts 108 that may meet these criteria. Posts 108 may all be substantially the same shape or may be different shapes and sizes to meet one or more functional criteria. Shapes may include round, oval, square, rectangular, hexagon, octagon, combinations thereof, and the like. In an example, posts 108 that may be assembled to either end of panels 102 and 104, or may be positioned at either horizontal end of base 112 may be partially rounded to eliminate the exposure of sharp corners. In another example, a portion of the posts 108 between such end posts 108 may have a smaller profile than the end posts. The smaller profiles (e.g. width and depth) may allow insertion into vertical apertures in a single panel embodiment. In an example, if the door guard 100 has an overall width of three inches, each panel 102 and 104 may each be approximately one-half inch thick and posts 108 may be two inches across. Other post shapes, combinations of shapes, various materials (e.g. plastic, lightweight steel, carbon fiber, composites, and the like) are included herein.

The panels 102 and 104 may be attached to the posts 108 with any of a variety of fastening devices and techniques that are suitable for attaching a resilient material, such as foam to a hard material such as aluminum (e.g. adhesive, automotive panel clips, bolts, and the like.) Alternatively, the posts 108 may include features that allow the panels 102 and 104 to be captured, such as a U-shaped channel near a top end and near a bottom end of the post. In yet another embodiment, the panels may be constructed, such as in the single panel or fused panel embodiments described herein with apertures that accept the posts 108 facilitating inserting the posts into the apertures with or without further attachment between the posts and the panels.

The base 112 may generally have a horizontally elongated shape that may be substantially the same length as the panels 102 and 104

The base 112 may include characteristics that are similar to the posts 108 such as those related to fabrication, materials, shapes, and features. While aluminum may be a good lightweight material for use in the base 112, due to the need for the base 112 to provide structural support through attachment to the posts 108, the floor supports 114, and the like, other materials may also be suitable including steel, alloys, and the like. In an example that may support the rectangular panel exampled described above, the base 112 may be a hollow rectangular shaped extrusion of aluminum with an end profile that is approximately two to three inches on each side and has a length of approximately sixty to seventy-two inches.

The posts 108 may be attached to the base 112 permanently (e.g. welding, casting as one piece, thermal fusing, bonding with adhesive, and the like), or may be removably attached (sheet metal screws, bolts and nuts or inserts, and the like). The base 112 may be fabricated with post retention features, such as slots or an aperture that may receive an end of a post 108 and may retain the post through slip fitting, press fitting, and the like. For such an embodiment, posts 108 may be fabricated with one end adapted to mate with a post retention feature of the base. Alternatively, the posts 108 may be attached to the base 112 through a flexible attachment, such as a firm spring that allows the posts (and therefore the vertical portion of the door guard apparatus 100) to tilt relative to the base. This added flexibility may further reduce the potential for damaging either a car door or the door guard 100 by allowing the vertical portion to tilt in response to a vehicle door impacting or pressing against it.

As described herein, floor supports 114 may be extended to rest on a parking surface, such as a garage parking space in which a vehicle may park. For the vehicle to be parked along side the door guard apparatus 100, it typically has to be driven or rolled into position. Therefore, the invention may support allowing a vehicle to be driven over the deployed floor supports 114. Consequently, the floor supports may preferably be constructed of a material that can withstand being repeatedly run over by the wheels of a vehicle—such as material may include steel, various metal alloys and the like. Each section of floor supports 114 may be fabricated by various metal fabrication techniques including extruding, cold rolling, hot rolling, and the like. The sections may be joined by, for example, metal hinges, pivot joints, and the like.

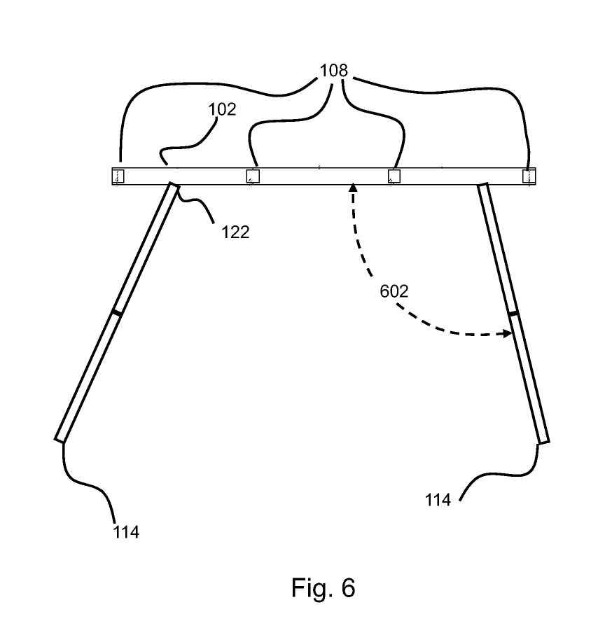

The floor supports 114 may be adjustable relative to the base 112 so that the floor supports can be positioned within a vehicle parking space or zone to facilitate parking the vehicle along side the door guard apparatus 100. Positioning the floor supports 114 may include unfolding the floor supports to be placed on the parking zone. The floor supports may also be positionable by rotating a deployed floor support relative to the base so that a horizontal angle formed between the base and the floor support may be other than ninety degrees (see FIG. 6). Consequently the floor supports 114 may be attached to the base 112 by a hip joint 122 that may include a hinge and/or by another type of adjustable feature, such as a hinge that is directly attached to the floor supports 114 and rotatably attached to the base 112.

The floor supports 114 may also be configured with an anti-slip receptacle 118 for attaching an anti slip device, such as a rubber foot. In an embodiment, the anti-slip receptacle 118 may be a hole in one or more sections of the floor supports 114 for receiving a snap-in rubber foot. The anti-slip receptacle may also be used with a fixturing device, such as a spike that may be driven from above through the anti-slip receptacle into the parking zone surface below. Such a configuration may be useful soft surface parking zones (grass, gravel, dirt, and the like). However, the anti-slip receptacle 118 could be used to facilitate affixing the floor supports 114 to a hard parking surface such as asphalt or concrete through use of a bolt or other fastener suitable for installation into such a hard parking surface.

The sections of the floor supports 114 may be joined at an expansion joint 120, such as by hinges as described herein. Alternatively, an expansion joint 120 may be a snap or press fit male-female type joint that allow one section to fit inside another section. Other joining techniques, including nut and bolt, snap-in pins, and the like are also contemplated for connecting sections of the floor supports 114. In embodiments, floor supports 114 may include only one section.

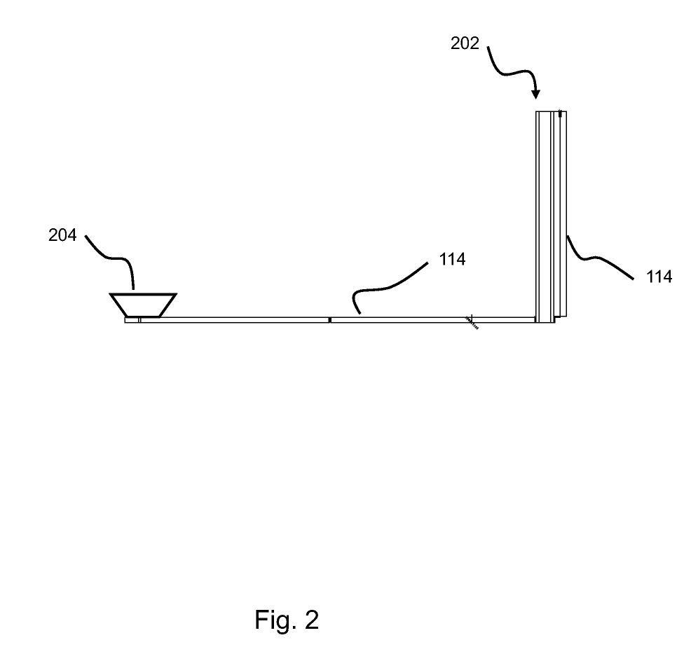

Referring to FIG. 2, while the embodiment of FIG. 1 depicts the door guard 100 with floor supports deployed on two opposite sides of the door guard 100, such as for positioning the door guard 100 between two parked cars, the door guard 100 may be deployed for a single vehicle application or in spaces where extending floor supports on two sides of the door guard 100 is impractical (e.g. in a one-car garage). Therefore, FIG. 2, which depicts the door guard 100 with floor supports deployed only on one side and retracted floor supports on the opposite side may apply to a one-vehicle parking/protection application. In the embodiment of FIG. 2, floor supports on a first vehicle-facing side are fully deployed in a horizontal orientation while the floor supports that are opposite the vehicle are kept folded-up against the vertical portion 202. In this deployment, the door guard 100 may facilitate protecting a door of a vehicle that is parked over the deployed floor supports 114 from being damaged due to opening the door against a hard or rough surface that is shielded by the door guard 100.

The door guard apparatus 100 may further include a roll stop 204 that may be attached to one of the floor supports 114. The roll stop 204 may provide substantial resistance to a rolling motion of a vehicle by interrupting the motion of one of the vehicle wheels. In an embodiment, the roll stop may be attached to a distal end of at least one of the floor supports 114. Alternatively, the roll stop may be disposed on a floor support close to the base 112.

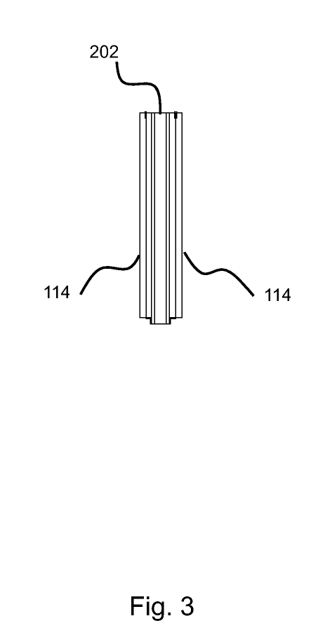

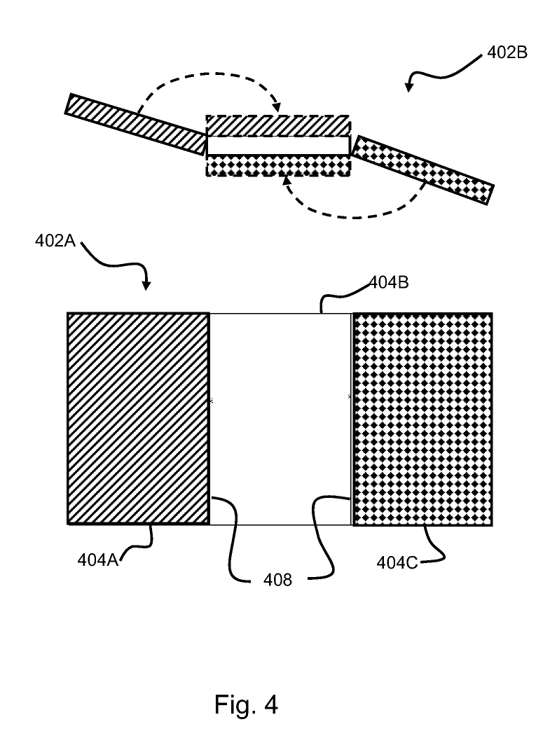

FIG. 3 depicts an embodiment of the door guard with all floor supports 114 retracted (e.g. folded) up against the door guard panels 102 and 104. Such a configuration may be suitable for shipment, storage, handling, and pre-deployment.

FIG. 4 depicts an embodiment of a foldable panel 402A variation of the invention in which panels 404 are connected by foldable interface section 408 to form a resilient, impact resistant panel that can be folded into thirds, such as for ease of packaging and transport. Foldable interface sections 408 may include a flexible material such as plastic, fabric, and the like. The foldable sections 408 may be a continuous element that spans substantially the full height of the panels, or they may comprise a plurality of individual interface elements that connect the panels. The interface sections 408 may be configured to allow the panel to fold in a collapsing ‘z’ shape resulting in panels 404A and 404C being folded against opposite sides of panel 404B, as shown in embodiment 402B of FIG. 4.

FIG. 5 depicts an embodiment of a foldable door guard apparatus shown in views 500A and 500B including three foldable panels 502 that are foldable in line with posts 108, a foldable base 510 that is also foldable at base folding joints 504. View 500A depicts a side view of the foldable door guard apparatus in a deployed or unfolded configuration. View 500B depicts an end view of the foldable door guard apparatus in a folded configuration and including folded floor supports 114, such as for storage, transport, and the like. In the embodiment of FIG. 5, foldable base 510 may include three sections, substantially aligned under each of three sections of foldable panel 502, each section hinged therebetween at base joints 504 substantially in line with two of the plurality of posts 108.

To further facilitate positioning a vehicle along side the door guard apparatus, a user may insert one or more flags 512 into a top edge of the apparatus 100. A vehicle operator may use one of the flags as a visual guide for positioning a vehicle in a parking zone (e.g. a garage) relative to the door guard apparatus. In an example, a driver may pull a vehicle in along side the door guard apparatus and align one of the flags that are disposed in the door guard to a feature on the vehicle, such as a side view mirror. This technique may allow the operator to gain the additional benefit of properly positioning the vehicle from use of the door guard apparatus. The one or more flags may be provided in a set of different colors and/or shapes that can be used for positioning different vehicles along side the door guard apparatus. In an example, a user may dispose a red square flag and a blue round flag into the door guard apparatus at two different locations and use the two flags for positioning two different vehicles. In an application of the door guard apparatus between two vehicle parking zones, such as in a two car garage, the red square flag may be used to align a vehicle being parked on one side of the door guard apparatus and the blue round flag for positioning a vehicle along the opposite side of the door guard apparatus. The different flags may also be used for positioning different vehicles in a parking zone next to the door guard apparatus. In this embodiment, one flag (e.g. the blue round flag) may be used when parking a small sedan in a parking space and another flag (e.g. the red square flag) may be used when positioning an SUV in the parking space.

FIG. 6 depicts a top view of a deployed embodiment of the invention that includes a single panel 102, a plurality of posts 108, and a set of floor supports 114. In the embodiment of FIG. 6, tops of the posts 108 are visible through post apertures configured in the panel 102. FIG. 6 further depicts a set of floor supports 114 deployed to one side of the panel 102 and positioned to form an angle 602 other than ninety-degrees relative to the base. The angle 602 may be formed by unfolding the floor supports 114 so that they are substantially horizontal, and then rotating each floor support 114 about a pivoting joint 122 between the base (not shown) and the floor support 114.

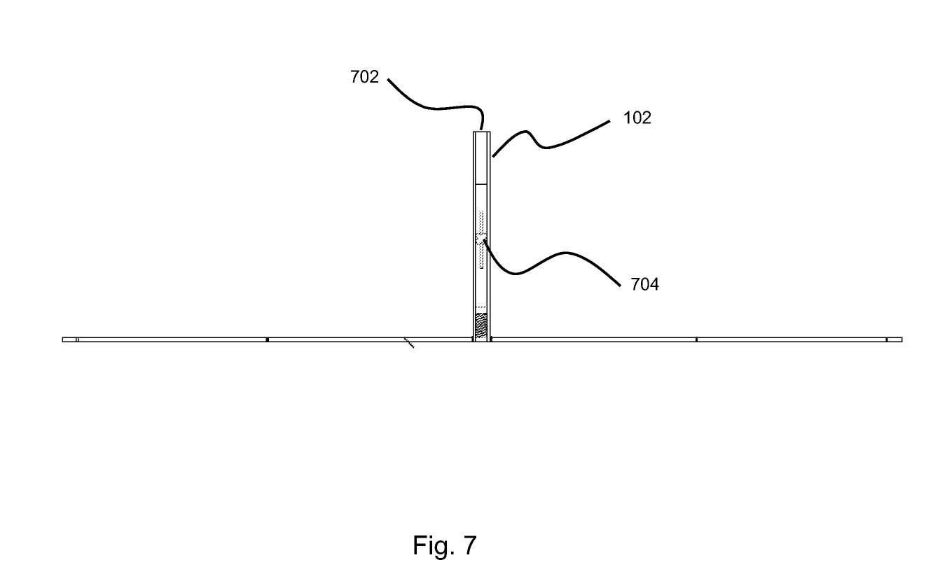

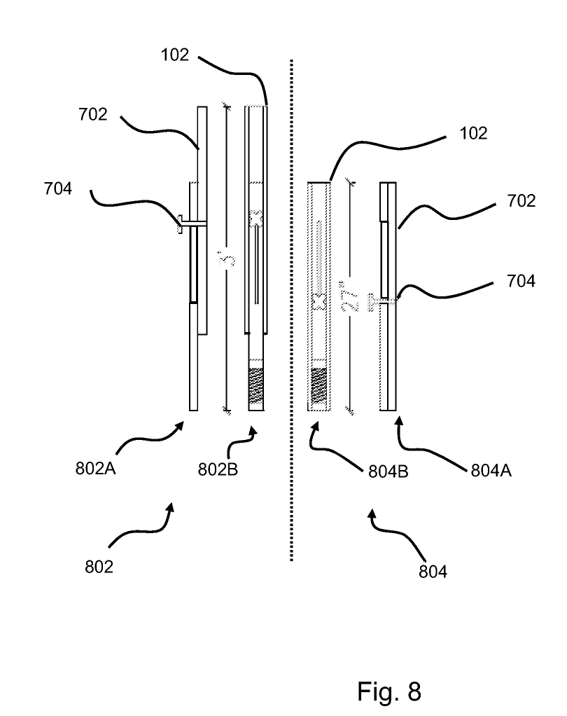

FIG. 7 depicts an end view of a height adjustable embodiment of the door guard apparatus. The door guard apparatus may be configured for height adjustability by using height adjustable posts 702. In the example of FIGS. 7 and 8, height adjustable posts 702 are adapted to include a first portion of each post that can slide vertically in relation to a second portion that is attached to the base. The posts may further include a vertical position locking knob 704 that facilitates holding the first and second portions of the posts in the selected relative vertical position. The panel 102 may be attached to the slidable portion of each post to facilitate positioning the panel at various heights relative to the base.

FIG. 8 depicts end and side views of the height adjustment mechanisms of the door guard apparatus in both an extended embodiment 802 and a compact embodiment 804. Extended embodiment 802 is shown in a side view 802A and an end view 802B. Side view 802A depicts height adjustable post 702 vertically extended to approximately three feet. Locking position knob 704 is shown extending through a slot in the fixed portion of the post 702 to facilitate locking the slidable portion of post 702 in the vertically extended position. The locking know 704 may retain the vertical position by a user turning the knob clockwise until it secures the two portions of the post 702 by pulling them together. A plurality of locking knobs (e.g. one at each end of the door guard apparatus) may be used to securely lock the door guard at a desired height.

Locking knob 704 may be loosened by turning it counterclockwise until the two slidable portions of post 702 can slide freely. When all locking knobs are loosened, the slidable portion of post 702 may be slid down to the compact position depicted in embodiment 804. The overall height of the compact door guard apparatus may be approximately twenty-seven inches. As can be seen in embodiments 802B and 804B, with the resilient, impact-absorbing panel attached to the slidable portion of the post 702, the panel may be positioned between approximately twenty-seven inches and thirty-six inches above the door guard base.

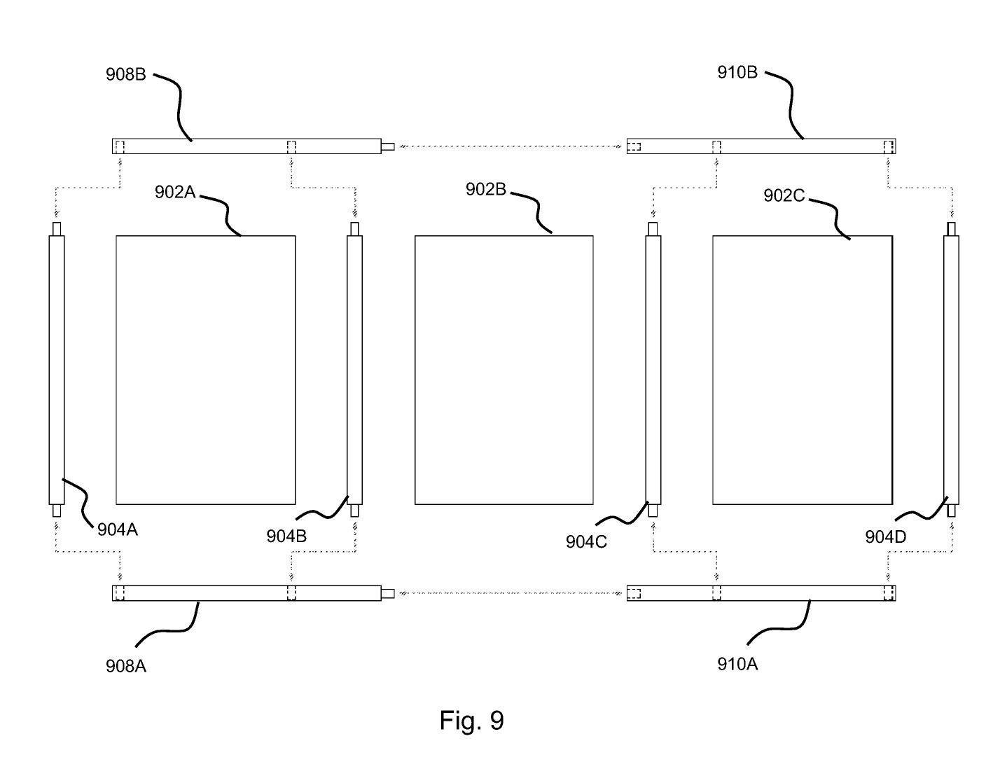

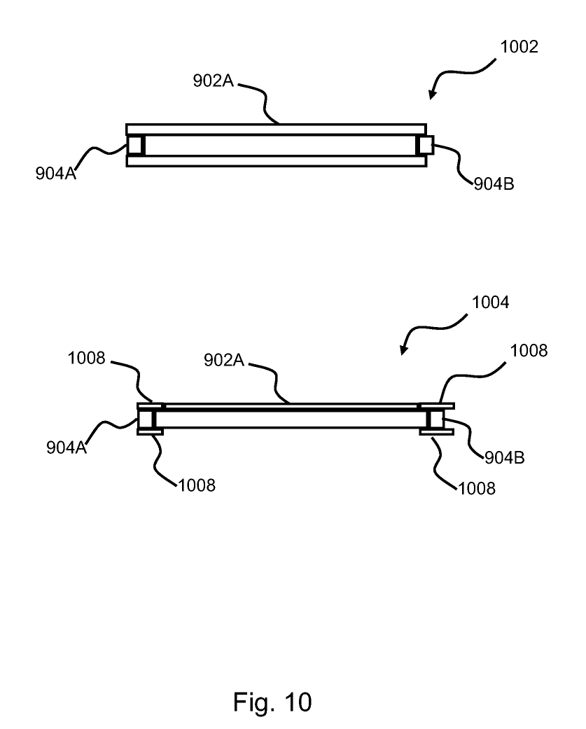

FIG. 9 depicts an exploded view of a portion of the door guard apparatus invention including three panel sections 902A-C, four posts 904A-D, left horizontal members 908A-B, and right horizontal members 910A-B. The embodiment of FIG. 9 may be assembled into a vertical portion of the door guard apparatus by placing the posts 904, left horizontal members 908 and right horizontal members 910 around panel sections 902 as shown, inserting the posts 904 into the left and right horizontal members as shown, and inserting the left horizontal members 908 into the right horizontal members 910 as shown. The panel sections 902 may be captured by the posts 904 and the attached horizontal members 908 and/or 910 so that the panel sections 902 remain fixed in position after assembly and during use as described herein. The posts 904 may be configured with ends that insert into receptacles disposed in the left and right horizontal members. Likewise, the left and right horizontal members may be configured with ends that facilitate assembly by mating left to right horizontal members to create a rigid frame in which the panel sections 902 are retained. In the example of FIG. 9, the left horizontal members 908 may include an end that may be inserted into receptacles configured into an end of the right horizontal members 910. Joints formed by the posts 904 with the horizontal members and between the horizontal members as shown in FIG. 9, may be made secure through a variety of means including, without limitation compression or forced-fit type insertion; adhesives (glue, adhesive pads, and the like); other types of surface to surface bonding (e.g. grooved surfaces, bump and depression mating, and the like); mechanical fasteners (screws, pins, snap rivets, and the like); and the like.

FIG. 10 depicts various top views of a portion of the embodiment of FIG. 10 partially assembled to show exemplary means for capturing a panel section. In the first embodiment 1002 of FIG. 10, panel section 902A as depicted is configured with outer surfaces that extend laterally to facilitate receiving posts 904A and 904B. When configured as shown in FIG. 10, panel section 902A ensures that posts 904 are not exposed along an impact absorbing portion of the door guard apparatus, thereby ensuring that a vehicle door will not impact the hard surface of a post.

Other embodiments are possible, such as embodiment 1004 in which the posts 904 are configured with impact absorbing material 1008 that facilitates capturing panel 902A. Note that embodiment 1004 also depicts an optional single sided embodiment of the door guard assembly that may be economically used in configurations that require protection of only one vehicle. Such an embodiment may also be offered at a reduced price when compared to the embodiment of FIG. 1002 that can be used to protect vehicles on either side of the apparatus. There are also a variety of alternative panel-to-post attachments that include, without limitation fitted shapes, pins and receptacles, and the like. All of these and other attachment concepts are included herein.

The door guard apparatus may also function as a protective shield for a vehicle from damage due to other objects, such as bicycles, lawnmowers, rubbish barrels, and the like that may be commonly found in garages. The door guard apparatus can protect a side of a car from an object falling against it. Deployment in a garage is one envisioned use of the door guard apparatus and garages can include other objects such as bicycles left leaning against a wall, pole, barrel, and the like but in proximity to the vehicle. Also, the door guard apparatus can protect a vehicle from damage caused by moving an object, such as a garbage barrel past the vehicle. The door guard apparatus can also function as a safety shield for an occupant exiting or entering a vehicle. By establishing a barrier between the vehicle door and other objects or vehicles in the vicinity of the vehicle door, upon exiting or entering a vehicle an occupant may be shielded from an object such as a falling bicycle, a door of an adjacent car being opened, and the like. This may be particularly beneficial for children entering or exiting a vehicle.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. An apparatus to facilitate preventing damage to external surfaces of a vehicle parked in a parking space, comprising:
a plurality of vertically elongated posts, each having a bottom end and a top end;
a first resilient, impact-absorbing panel overlaying a portion of at least one vertical face of the plurality of posts, the panel attached to the posts;
a base attached below the bottom end of the plurality of posts, thereby holding the posts and panel upright; and
a plurality of adjustable floor supports moveably attached to the base for positioning the base aligned with and proximal to the vehicle parking space with the impact absorbing panel being disposed between the parking space and the posts, the floor supports resting on the parking space.

2. The apparatus of claim 1, further including a second resilient impact absorbing panel overlaying a vertical face of the plurality of posts opposite the first panel, the second panel attached to the posts, thereby disposing the second panel between the posts and an adjacent parking space.

3. The apparatus of claim 1, wherein the first resilient, impact absorbing panel overlays a portion of a vertical face of the plurality of posts that is opposite to the vertical face overlaid by the panel, thereby disposing the impact absorbing panel between the posts and an adjacent parking space.

4. The apparatus of claim 1, wherein the base comprising three segments attached by hinges therebetween and the panel comprising three sections flexibly attached therebetween above the hinges for folding the apparatus horizontally.

5. The apparatus of claim 1, wherein the plurality of posts each comprises two sections that are slidably attached; a first section holding the panel and being vertically slidable relative to a second section attached to the base.

6. The apparatus of claim 5, wherein the panel can be vertically positioned so that an upper extent of the panel is positionable in the range of 27″ to 36″ above the parking space by sliding the first post section upward relative to the second post section.

7. The apparatus of claim 1, wherein at least one of the adjustable floor supports includes a proximal end for attaching to the base and a distal end that comprises a roll stop to facilitate positioning a vehicle relative to the apparatus.

8. An apparatus for preventing damage to facing sides of two vehicles parked in adjacent parking spaces, the damage resulting from opening a door of one of the vehicles toward the other vehicle, comprising:
a resilient door guard having left and right impact absorbing surfaces and a top surface;
a horizontally elongated base;
a plurality of posts attached to the base and extending upward from the base, wherein the plurality of posts is disposed between the left and right impact absorbing surfaces of the door guard thereby holding the door guard upright; and
a plurality of adjustable floor supports resting on at least one of the parking spaces and moveably attached to the base for stably maintaining the door guard between the two vehicles.

9. The apparatus of claim 8, wherein the base comprising three segments attached by hinges therebetween and wherein the door guard comprises three sections flexibly attached therebetween above the hinges for folding the apparatus horizontally.

10. The apparatus of claim 8, wherein the plurality of posts each comprises two sections that are slidably attached; a first section holding the door guard and being vertically slidable relative to a second section attached to the base.

11. The apparatus of claim 10, wherein the door guard can be vertically positioned so that door guard top surface can be positioned in the range of 27″ to 36″ above the parking space by sliding the first post section upward relative to the second post section.

12. The apparatus of claim 8, wherein the posts are mounted to the base by a spring for allowing the door guard to tilt relative to the base in response to the vehicle door impacting the door guard.

13. The apparatus of claim 8, further including a plurality of flags for disposing at various horizontal positions along a top of the door guard.

14. The apparatus of claim 13, wherein disposing at various horizontal positions includes pushing a portion of the flag into the door guard through the door guard top surface.

15. The apparatus of claim 8, wherein at least one of the adjustable floor supports includes a proximal end for attaching to the base and a distal end that comprises a roll stop to facilitate positioning a vehicle relative to the apparatus.

16. The apparatus of claim 8, wherein the floor supports facilitate the door guard remaining upright in response to an impact from an opening car door.

17. A method of preventing damage to a vehicle door parked on a parking surface, comprising:
disposing a resilient impact absorbing door guard in a vertical orientation over a horizontally elongated base that is positioned aside the vehicle door;
supporting the base with a plurality of floor supports that are moveably attached to the base and that rest on the parking surface; and
supporting the impact absorbing door guard with posts that are mounted to the base, wherein the door guard is disposed between the vehicle and the posts.

18. The method of claim 17, wherein the posts are mounted to the base by a spring for allowing the door guard and posts to tilt relative to the base in response to the vehicle door impacting the door guard.

19. The method of claim 17, wherein at least one of the floor supports includes a proximal end for attaching to the base and a distal end that comprises a roll stop to facilitate positioning a vehicle relative to the door guard.

20. The method of claim 17, wherein the resilient impact absorbing door guard is positioned within an opening radius of the vehicle door.
